(19) United States
(12) Patent Application Publication
(10) Pub. No.: US 2017/0060357 A1
(43) Pub. Date: Mar. 2, 2017

(54) TOUCH PANEL TYPE OPERATION TERMINAL, TOUCH PANEL TYPE OPERATION METHOD, AND RECORDING MEDIUM

(71) Applicant: FUJITSU LIMITED, Kawasaki-shi (JP)

(72) Inventors: Takafumi Segawa, Osaka (JP); Teruyuki Watanabe, Souka (JP); Isao Magara, Kawasaki (JP)

(21) Appl. No.: 15/251,666

(22) Filed: Aug. 30, 2016

(30) Foreign Application Priority Data
Sep. 1, 2015 (JP) 2015-171697

(51) Int. Cl. G06F 3/0482; G06F 3/0488; G06F 3/041

(52) U.S. Cl. CPC G06F 3/0482; G06F 3/0412; G06F 3/0488

(57) ABSTRACT

A touch panel type operation terminal that is configured to operate in a first operation mode and a second operation mode; and includes a touch panel type display and a control circuit configured to carrying out switching control between the first operation mode and the second operation mode according to simultaneous operations to a plurality of predetermined regions of the touch panel type display.

### CROSS REFERENCE TO RELATED APPLICATIONS

This application is based upon and claims the benefit of priority of the prior Japanese Patent Application No. 2015-171697, filed on Sep. 1, 2015, the entire contents of which are incorporated herein by reference.

### FIELD

The embodiments discussed herein are related to a touch panel type operation terminal, a touch panel type operation method, and a recording medium.

### BACKGROUND

A conventional touch panel type display detects an operation of a finger touch. Related prior art includes, for example, a technique of identifying holding positions at which fingers other than the thumb of a user's hand holding a housing contact with a touch panel, so as to change a selected item sequentially according to an operation with the thumb of the hand holding the housing or with the hand not holding the housing. For example, refer to Japanese Laid-Open Patent Publication No. 2014-052791.

### SUMMARY

According to an aspect of an embodiment, a touch panel type operation terminal that is configured to operate in a first operation mode and a second operation mode; and includes a touch panel type display and a control circuit configured to carrying out switching control between the first operation mode and the second operation mode according to simultaneous operations to a plurality of predetermined regions of the touch panel type display.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an operation example of a touch panel type operation terminal 101 according to the present embodiment;

FIG. 2 is an explanatory diagram of an example of a banking center system 200;

FIG. 3 is a diagram depicting one example of hardware configuration of a tablet terminal 203;

FIG. 4 is a diagram depicting one example of hardware configuration of a banking-center counter terminal 205;

FIG. 5 is an explanatory diagram of an example of transfer work in the banking center system 200;

FIG. 6 is an explanatory diagram of a functional configuration example of the tablet terminal 203;

FIG. 7 is an explanatory diagram of an example of storage contents of a highlighting table 611;

FIG. 8 is an explanatory diagram of an example of registration of confirmation items to the highlighting table 611 in a normal mode;

FIG. 9 is an explanatory diagram (part one) of an operation example in an explanation mode;

FIG. 10 is an explanatory diagram (part two) of an operation example in the explanation mode;

FIG. 11 is an explanatory diagram (part three) of an operation example in the explanation mode;

FIG. 12 is an explanatory diagram (part four) of an operation example in the explanation mode;

FIG. 13 is an explanatory diagram (part five) of an operation example in the explanation mode;

FIG. 14 is an explanatory diagram (part six) of an operation example in the explanation mode;

FIG. 15 is a flowchart of an example of a transfer procedure process procedure;

FIG. 16 is a flowchart (part one) of an example of a customer confirmation process procedure;

FIG. 17 is a flowchart (part two) of an example of the customer confirmation process procedure; and

FIG. 18 is a flowchart of an example of a highlighting process procedure.

### DESCRIPTION OF THE INVENTION

Embodiments of a touch panel type operation terminal, a touch panel type operation method, and a recording medium of the present disclosure will be described in detail with reference to the accompanying drawings.

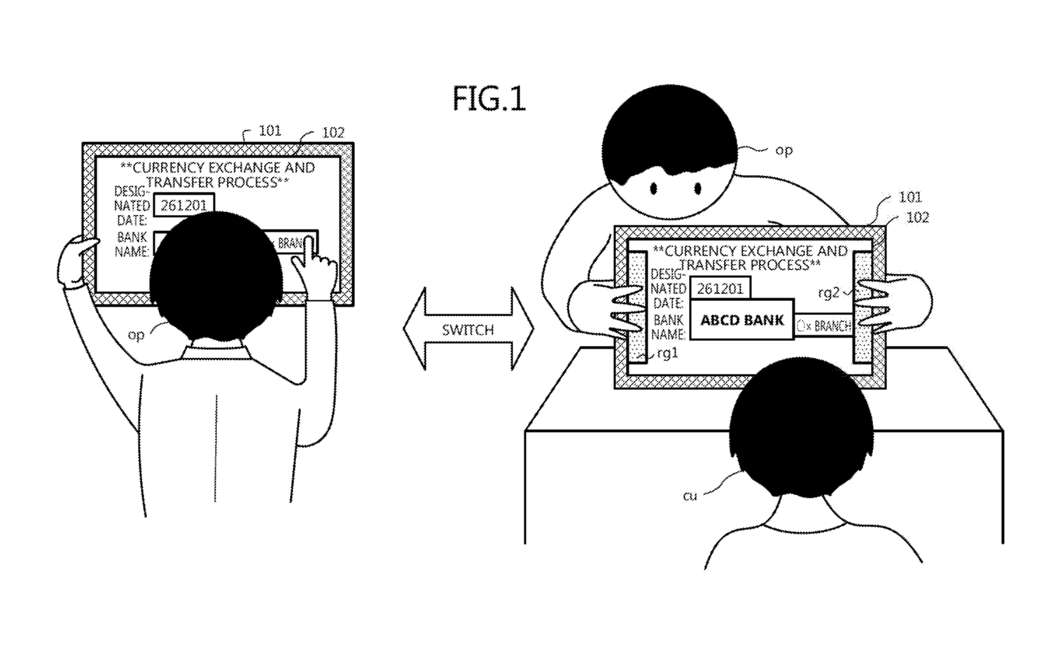

FIG. 1 is an explanatory diagram of an operation example of a touch panel type operation terminal 101 according to the present embodiment. The touch panel type operation terminal 101 is an operation terminal having a touch panel type display 102. The touch panel type display will simply be referred to as a “touch panel” hereinafter. For example, the touch panel type operation terminal 101 is a tablet terminal or a smart phone. The touch panel type operation terminal 101 is used by an explainer, i.e., an operator operating the touch panel type operation terminal 101, for work of giving explanation of the contents displayed on the touch panel 120 to a person receiving the explanation while presenting the touch panel 102 to the person receiving the explanation. For example, the operator is a person providing some kind of service and the person receiving the explanation is a person receiving some kind of service.

For example, in an operation example in the case of a financial institution, the operator is an operator in the financial institution, and the person receiving the explanation is a customer receiving a service from the financial institution. Alternatively, the operator may be a sales representative of the financial institution visiting the customer. In such a case, the touch panel 102 displays a screen showing a service provided by the financial institution. The service provided by the financial institution may be a bank transfer procedure or a housing loan, for example.

For example, with regard to a bank transfer procedure, the operator accepts a bank transfer form filled in by a customer so as to execute a subsequent process on the financial institution side. In this case, the customer may feel anxious about whether the bank transfer is actually performed. In the case of a housing loan, explanation of contract clauses is required; however, if the explanation is given based on a document stating the contract clauses, the customer may not understand what is actually important in some situations.

Therefore, it is conceivable that the explanation may be given by using the touch panel type operation terminal to present information for giving the explanation in more detail and deepening the customer's understanding. Additionally, the touch panel type operation terminal enables giving detailed explanation of a transaction to a customer and obtaining confirmation from the customer regardless of location even in a place where a banking center dedicated terminal of the financial institution is not disposed nearby, and only requires a small capital investment for a system.

However, it is troublesome to perform work associated with explaining the contents on a screen while the screen of the touch panel type display is presented. For example, when explanation is given to a customer by using the touch panel type operation terminal, an operator behind the touch panel type operation terminal faces the touch panel type operation terminal toward the customer and performs operations while highlighting items etc. by using a pointing device or a finger. In this case, the operation using the pointing device or the finger blocks the line of sight of the customer and makes it difficult for the customer to comfortably listen to the explanation, interfering with the customer's understanding.

Therefore, when giving an explanation, the operator must operate the terminal with care so as not to block the line of sight of the customer with respect to the information displayed on the terminal, and the operation is difficult to perform in a normal operation mode. Thus, it is desirable to provide a dedicated operation mode in which an operation is easily performed even without blocking the line of sight of a person receiving the explanation when the explanation is given. For example, it is conceivable that the dedicated operation mode may be an operation mode in which a selected item is changed sequentially according to an operation of the touch panel type operation terminal with a thumb of a hand holding a housing, or a hand not holding the housing. If the dedicated operation mode is provided, setting must be changed from the normal operation mode to the dedicated operation mode before explanation and setting must be changed from the dedicated operation mode to the normal operation mode after explanation.

In the present embodiment, description will be given of switching according to simultaneous operations to both ends of a screen between a first operation mode in which the touch panel type operation terminal 101 can be operated without blocking the line of sight of the customer and a second operation mode in which the touch panel type operation terminal 101 can be operated as usual.

In FIG. 1, the touch panel type operation terminal 101 switches between the first operation mode and the second operation mode according to simultaneous operations to predetermined multiple regions of the touch panel 102. The first operation mode may be any mode as long as the touch panel type operation terminal 101 can be operated without blocking the line of sight of the customer to the touch panel 102. For example, the first operation mode is a mode with limited regions accepting operations or with limited operations. The mode with limited operations is, for example, a mode in which only predefined operations are accepted while an operation other than the predefined operation is not accepted.

On the other hand, the second operation mode is an operation without particular limitation. The first operation mode will hereinafter be referred to as an “explanation mode”. The second operation mode will be referred to as a “normal mode”.

The predetermined multiple regions may be regions at ends of the touch panel 102 so as not to block the line of sight of the customer. For example, the predetermined multiple regions are regions at both ends of the touch panel 102. The regions at both ends of the touch panel 102 may be a left edge region and a right edge region of the touch panel 102 or may be an upper edge region and a lower edge region of the touch panel 102. The predetermined multiple regions may be two or more regions and may be three regions, for example. The shape of the touch panel 102 may be any shape and is, for example, a rectangle, a square, or a quadrangle with round corners.

The simultaneous operations to the predetermined multiple regions may be any operations that can be performed at the same time, and are, for example, operations of touching at the same time or operations of terminating touching at the same time. For example, the touch panel type operation terminal 101 may switch between the explanation mode and the normal mode each time fingers of both hands of the operator touch the predetermined multiple regions. Alternatively, the touch panel type operation terminal 101 may be in the explanation mode only while fingers of both hands are touching the predetermined regions and may switch to the normal mode when the operator's fingers are removed from the regions.

With regard to the simultaneous operations, the touch panel type operation terminal 101 may recognize the simultaneous operations when fingers of both hands of the operator substantially simultaneously touch the predetermined respective multiple regions. Alternatively, while fingers of one hand of the operator are continuously touching any of the predetermined multiple regions, the touch panel type operation terminal 101 may recognize the simultaneous operations when fingers of the other hand of the operator touch another region.

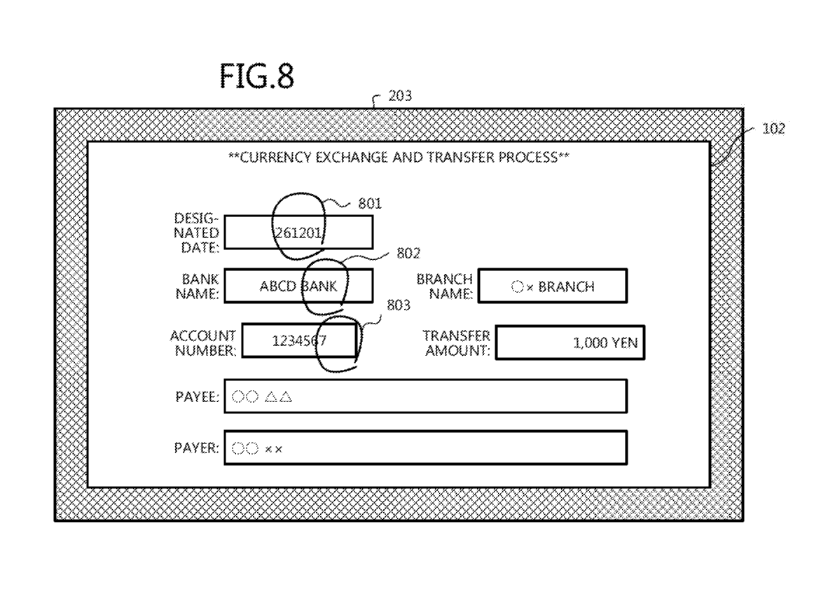

FIG. 1 depicts the touch panel type operation terminal 101 in the normal mode on the left side and depicts the touch panel type operation terminal 101 in the explanation mode on the right side. The touch panel type operation terminal 101 in the normal mode depicted in FIG. 1 is used by an operator op without particular limitation. For example, the touch panel type operation terminal 101 in the normal mode displays a screen displayed in the explanation mode, and the order of highlighting of confirmation items to be confirmed with a customer cu is registered according to an operation by the operator op among items displayed on the screen. An example of registering the confirmation items will be described with reference to FIG. 8.

The touch panel type operation terminal 101 in the normal mode switches from the normal mode to the explanation mode according to the simultaneous operations to the predetermined multiple regions of the touch panel 102 performed in conjunction with an operation of directing the touch panel 102 to the customer cu performed by the operator op. The touch panel type operation terminal 101 in the explanation mode depicted in FIG. 1 has the touch panel 102 directed by the operator op to the customer while the simultaneous operations are performed to the predetermined multiple regions, i.e., regions rg1, rg2. The region rg1 is a left edge region of the touch panel 102. The region rg2 is a right edge region of the touch panel 102. In the example of FIG. 1, when it is assumed that the lower left of the touch panel 102 is the origin, the region rg1 is a rectangle having a point (0, the height of the touch panel 120—predetermined length) and a point (predetermined length, predetermined length) as vertexes. The predetermined length is a preset value specified by a designer or the operator op of the touch panel type operation terminal 101. For example, the operator op may specify as the predetermined length a smallest value of right and left margin widths of screen contents displayed on the touch panel 102. The width of the region rg1 and the width of the region rg2 may have mutually different values.

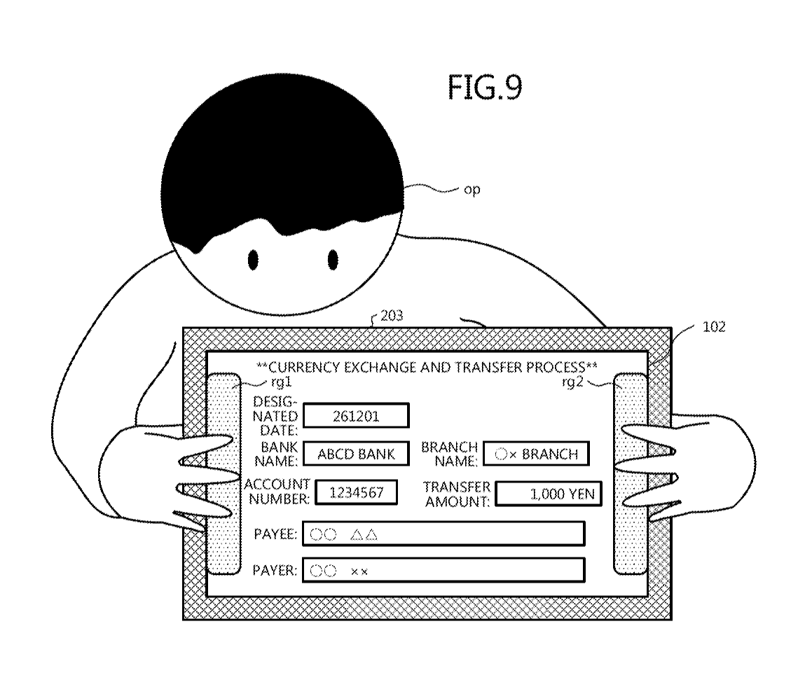

The touch panel type operation terminal 101 in the explanation mode depicted in FIG. 1 highlights a bank name “ABCD BANK” displayed on the touch panel 102 according to an operation by the operator op to either of the regions rg1, rg2. With regard to the highlighting, the touch panel type operation terminal 101 may highlight a value of a confirmation item or may highlight a value and a confirmation item name of a confirmation item. A value of a confirmation item may be a character string or an image. An example of highlighting the confirmation items will be described with reference to FIGS. 9 to 14.

In FIG. 1, the regions rg1, rg2 are lightly shaded regions. The touch panel type operation terminal 101 may display the regions rg1, rg2 so that the operator op can identify the regions rg1, rg2, or may not display the regions rg1, rg2. A heavily shaded region of the touch panel type operation terminal 101 of FIG. 1 indicates a housing portion of the touch panel type operation terminal 101.

As described above, the touch panel type operation terminal 101 may switch from the normal mode to the explanation mode according to an operation easily performed when the screen contents are explained with the screen presented to the customer cu, and may facilitate the work associated with the explanation. The touch panel type operation terminal 101 enables the operator to highlight the confirmation items without blocking the line of sight of the customer cu and can suppress interference with the understanding by the customer cu.

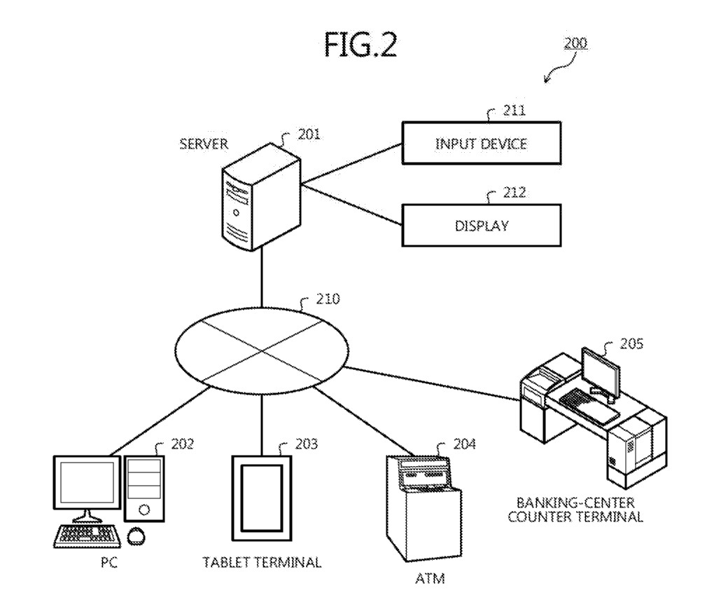

Although FIG. 1 depicts the state in which the operator op uses the longitudinal direction of the touch panel type operation terminal 101 as the horizontal direction, the present embodiment is also applicable to a state in which the longitudinal direction of the touch panel type operation terminal 101 is used as the vertical direction. Although the operator is an operator op of a financial institution and the person receiving the explanation is the customer cu receiving a service of the financial institution in FIG. 1, this is not a limitation. For example, the operator may be a sales representative of an insurance company. Alternatively, for example, the present embodiment is also applicable when a parent or a nursery school teacher acting as the operator reads a picture book displayed on the touch panel type operation terminal 101 to a child corresponding to a person receiving the explanation at home or in a childcare facility. In this case, the touch panel type operation terminal 101 may be controlled such that page transition does not occur even if a child touches the screen in the explanation mode. An example of a case of using the touch panel type operation terminal 101 in a banking center system used in a finance institution will be described with reference to FIG. 2.

FIG. 2 is an explanatory diagram of an example of a banking center system 200. The banking center system 200 includes a server 201, a personal computer 202, a tablet terminal 203, an automatic teller machine (ATM) 204, and a banking-center counter terminal 205. The banking center system 200 is a system of a banking center of a certain bank. The server 201 to the banking-center counter terminal 205 are each connected by a network 210 such as a local area network (LAN) and a wide area network (WAN). The tablet terminal 203 corresponds to the touch panel type operation terminal 101 depicted in FIG. 1.

The server 201 is a computer controlling the banking center system 200. For example, the server 201 stores a data base and a table storing account information of the customer cu. When performing a bank transfer to another bank, the server 201 communicates with the other bank. The server 201 has an input device 211 such as a mouse and a keyboard, and a display 212 for direct operation by the operator op.

The personal computer 202 is a computer operated by the operator op. The tablet terminal 203 is a computer operated by the operator op for giving an explanation to the customer cu.

The ATM 204 is a machine from which a service provided by the banking center can be received according to an operation performed by the customer cu himself/herself. The ATM 204 has reception and payment ports for paper money, coins, a bankbook, a magnetic card, etc. The banking-center counter terminal 205 is a computer disposed on a counter of a banking center and operated by the operator op. For example, the banking-center counter terminal 205 takes in a transfer form, a withdrawal form, etc. filled out by the customer cu.

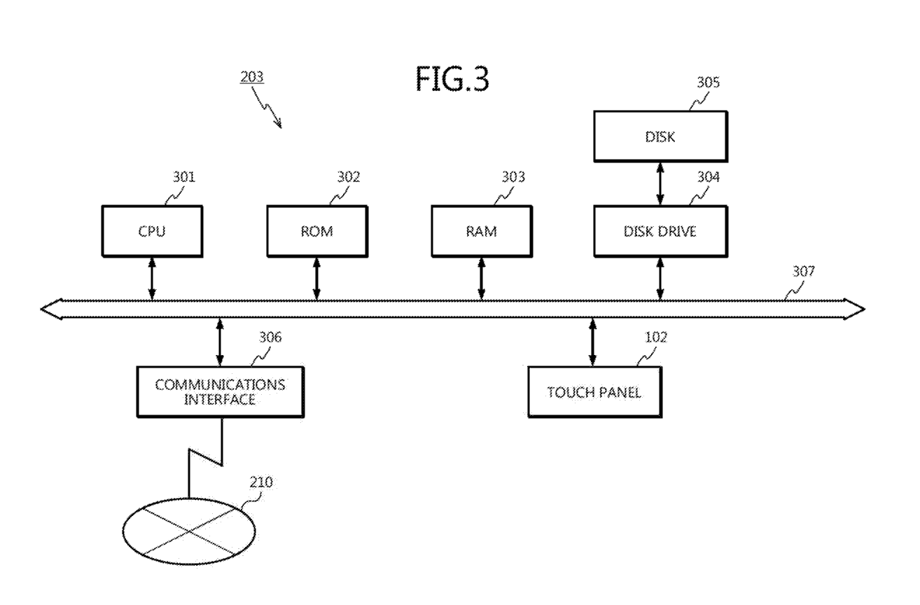

FIG. 3 is a diagram depicting one example of hardware configuration of the tablet terminal 203. In FIG. 3, the tablet terminal 203 includes a central processing unit (CPU) 301, read-only memory (ROM) 302, random access memory (RAM) 303, a disk drive 304, a disk 305, a communications interface 306, and the touch panel. Further, the CPU 301 to the disk drive 304, the communications interface 306, and the touch panel are connected by a bus 307.

Here, the CPU 301 is a computation processing apparatus that governs overall control of the tablet terminal 203. The ROM 302 is non-volatile memory storing programs such as a boot program. The RAM 303 is volatile memory used as a work area of the CPU 301. The disk drive 304 is a control apparatus that under the control of the CPU 301, controls the reading and writing of data with respect to the disk 305. The disk 305 stores data written thereto under the control of the disk drive 304. The disk drive 304, for example, may be a magnetic disk drive, a solid state drive, etc. For example, when the disk drive 304 is a magnetic disk drive, the disk 305 may be a magnetic disk. Further, when the disk drive 304 is a solid state drive, the disk 305 may be semiconductor memory formed by a semiconductor device, a so-called semiconductor disk may be employed.

The communications interface 306 is a control apparatus that administers an internal interface with the network 210 and controls the input and output of data from other apparatuses. In particular, the communications interface 306 is connected to other apparatuses through a communications line, via the network 210.

The touch panel is an apparatus that combines sensors that detect touch and drag operations by the operator op and a display that displays data such as functional information, images, and documents in addition to a cursor, icons, and toolboxes. In particular, the sensors are superimposed on the display. Further, the sensors are configured to detect multiple points simultaneously and, for example, are sensors employing a projected capacitive touch scheme. The display, for example, may be a thin film transistor (TFT) liquid crystal display, or the like.

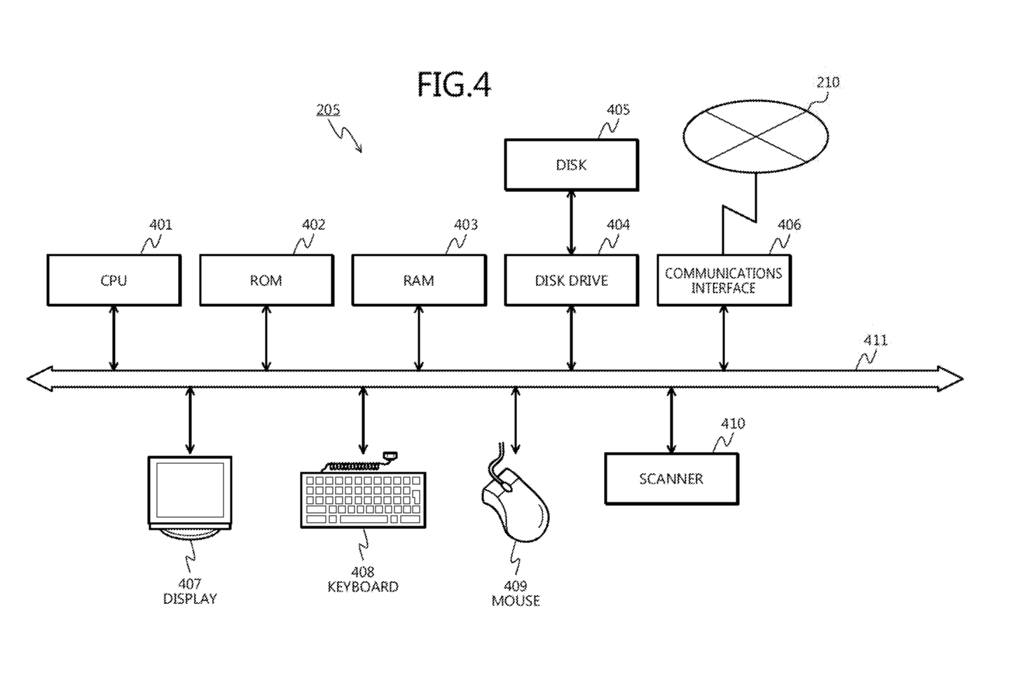

FIG. 4 is a diagram depicting one example of hardware configuration of the banking-center counter terminal 205. The banking-center counter terminal 205 includes a CPU 401, ROM 402, RAM 403, a disk drive 404, a disk 405, a communications interface 406, a display 407, a keyboard 408, a mouse 409, and a scanner 410. The CPU 401 to the disk drive 404, and the communications interface 406 to the scanner 410 are connected by a bus 411.

The CPU 401 is a computation processing apparatus that governs overall control of the banking-center counter terminal 205. The ROM 402 is non-volatile memory storing programs such as a boot program. The RAM 403 is volatile memory used as a work area of the CPU 401.

The disk drive 404 is a control apparatus that, under the control of the CPU 401, controls the reading and writing of data with respect to the disk 405. The disk drive 404, for example, may be a magnetic disk drive, an optical disk drive, a solid state disk drive, etc. The disk 405 is non-volatile memory storing data written thereto under the control of the disk drive 404. For example, when the disk drive 404 is a magnetic disk drive, the disk 405 may be a magnetic disk. When the disk drive 404 is an optical disk drive, the disk 405 may be an optical disk. Further, when the disk drive 404 is a solid state drive, the disk 405 may be semiconductor memory formed by a semiconductor device, a so-called semiconductor disk may be employed.

The communications interface 406 is a control apparatus that administers an internal interface with the network 210, and controls the input and output of data from external apparatuses. In particular, the communications interface 406 is connected to other apparatuses through a communications line, via the network 210. The communications interface 406, for example, may be a modem, a LAN adapter, etc.

The display 407 is an apparatus that displays data such as documents, images, functional information, etc. in addition to a mouse cursor, icons, and toolboxes. The display 407, for example, may be a cathode ray tube (CRT), a TFT liquid crystal display, a plasma display, etc.

The keyboard 408 is an apparatus that has keys for inputting characters, numerals, various instructions, etc. and performs data input. The keyboard 408 may be a touch panel type input pad, numeral pad, etc. The mouse 409 is an apparatus that moves the mouse cursor, selects a range, moves and changes the size of windows, etc. The mouse 409 may be a trackball, joystick, etc. provided that functions identical to a pointing device are included.

The scanner 410 optically reads images and takes in image data into the banking-center counter terminal 205. The scanner 410 may have an optical character reader (OCR) function.

The server 201 has the CPU, the ROM, the RAM, the disk drive, the disk, and the communications interface. The computer 202 has the CPU, the ROM, the RAM, the disk drive, the disk, the communications interface, the keyboard, and the mouse.

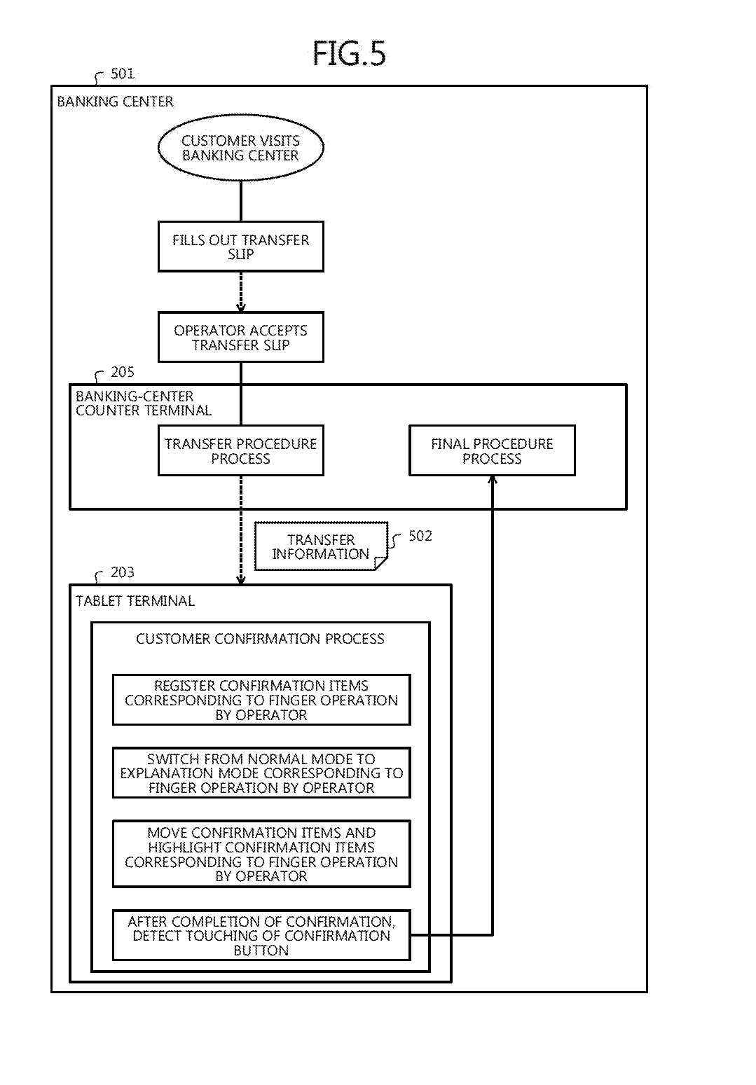

An example of details of transfer work will be described as an example of work contents in the banking center system 200 with reference to FIG. 5.

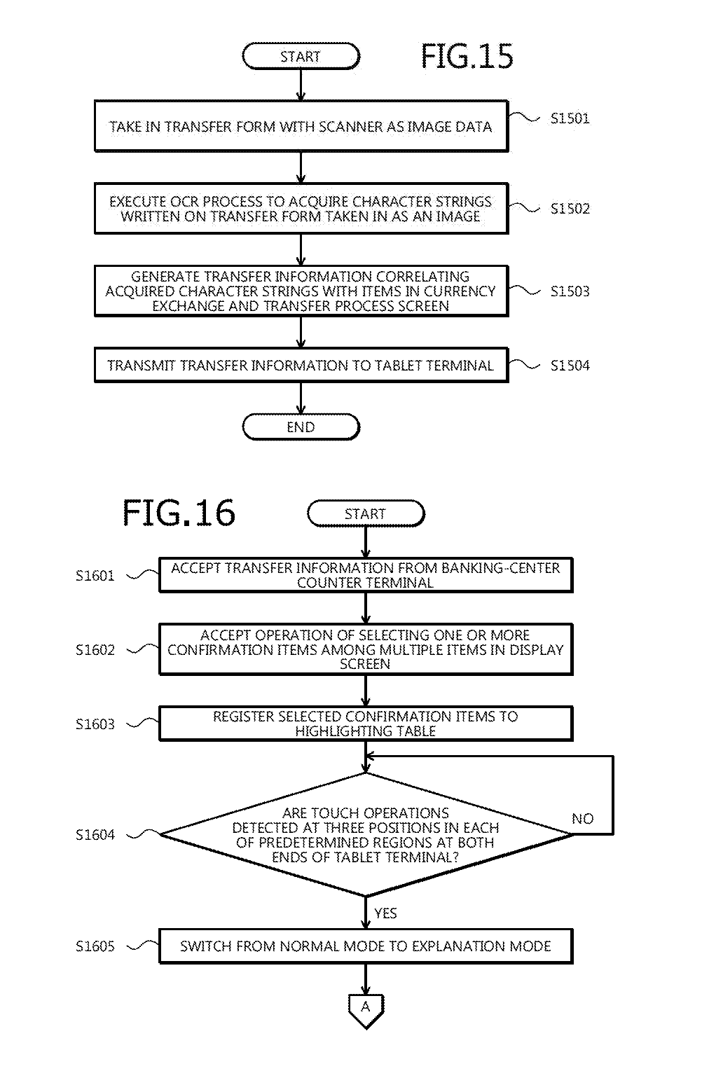

FIG. 5 is an explanatory diagram of an example of the transfer work in the banking center system 200. First, the customer cu visits a banking center 501 and fills out a transfer slip. The operator op accepts the written transfer slip from the customer cu at the counter. The banking-center counter terminal 205 executes a transfer procedure process according to an operation by the operator op. Details of the transfer procedure process will be described with reference to FIG. 15. When executing the transfer procedure process, the banking-center counter terminal 205 transmits to the tablet terminal 203, transfer information 502 correlating character strings written on a transfer form with items in a currency exchange and transfer process screen displayed on the tablet terminal 203. Specific contents of the transfer information 502 will be described with reference to FIG. 15.

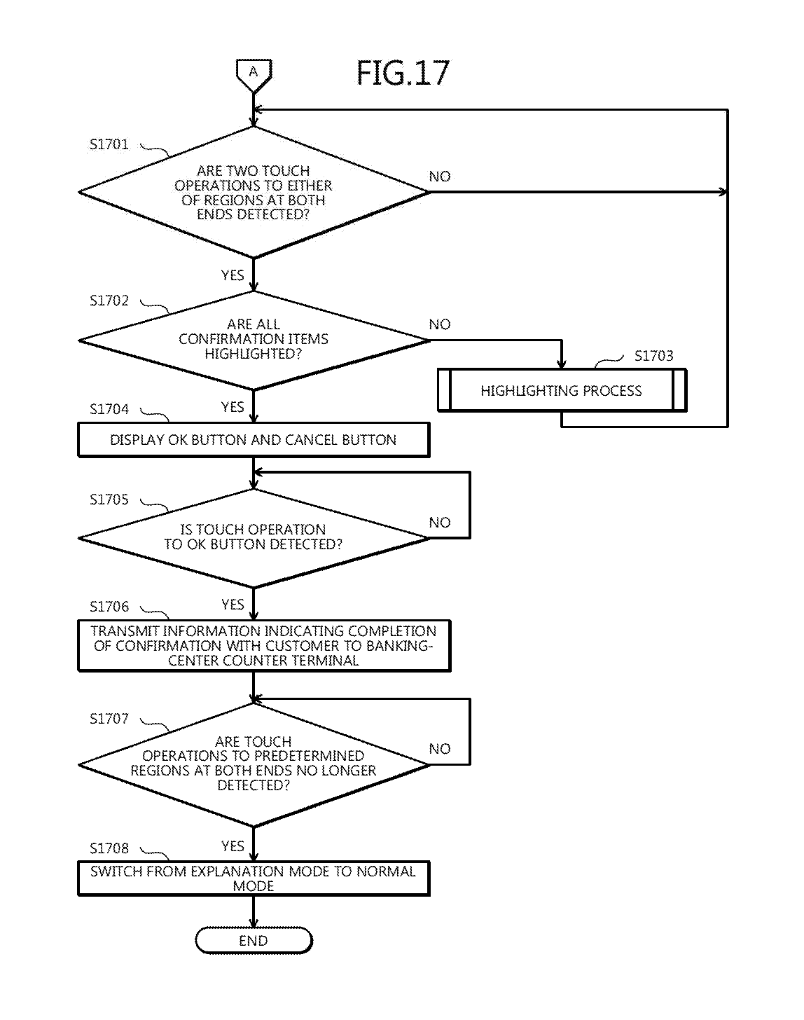

After accepting the transfer information 502, the tablet terminal 203 executes a customer confirmation process according to an operation by the operator op. Details of the customer confirmation process will be described with reference to FIGS. 16 and 17. For example, in the customer confirmation process, the tablet terminal 203 registers the confirmation items among the items in the currency exchange and transfer process screen corresponding to a finger operation by the operator op. In the customer confirmation process, the tablet terminal 203 switches from the normal mode to the explanation mode corresponding to a finger operation by the operator op. In the customer confirmation process, the tablet terminal 203 moves the confirmation items and highlights the confirmation items corresponding to a finger operation by the operator op. After completion of confirmation of the confirmation items, when detecting a touching of a confirmation button by the customer cu, the tablet terminal 203 transmits information indicating the completion of confirmation with the customer cu to the banking-center counter terminal 205.

When accepting the information indicating the completion of confirmation with the customer cu, the banking-center counter terminal 205 executes a final procedure process. For example, the banking-center counter terminal 205 transmits the transfer information 502 to the server 201 for the final procedure process. The server 201 refers to the accepted transfer information 502 and, for example, if a transfer destination is an account of another bank, the server 201 executes a transfer process in cooperation with a server of the other bank.

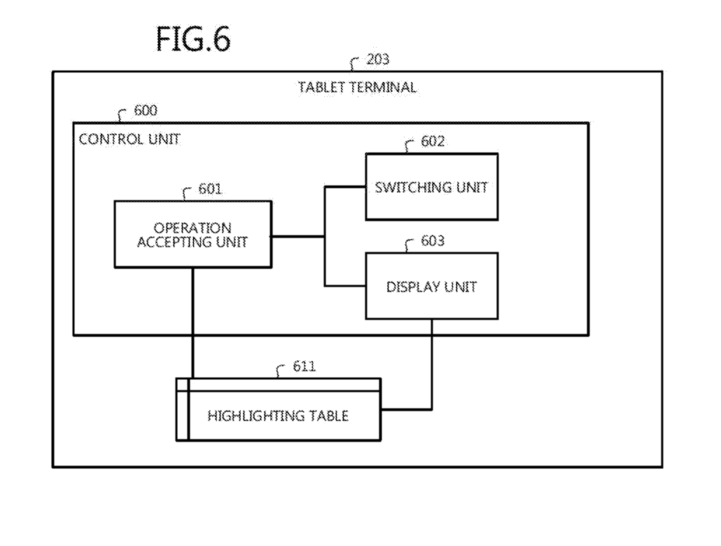

FIG. 6 is an explanatory diagram of a functional configuration example of the tablet terminal 203. The tablet terminal 203 has a control unit 600. The control unit 600 includes an operation accepting unit 601, a switching unit 602, and a display unit 603. The control unit 600 implements functions of the units when the CPU 301 executes a program stored in a storage device. The storage device is, for example, the ROM 302, the RAM 303, or the disk 305 depicted in FIG. 3. Process results of the units are stored to a register of the CPU 301, a cache memory of the CPU 301, the RAM 303, etc.

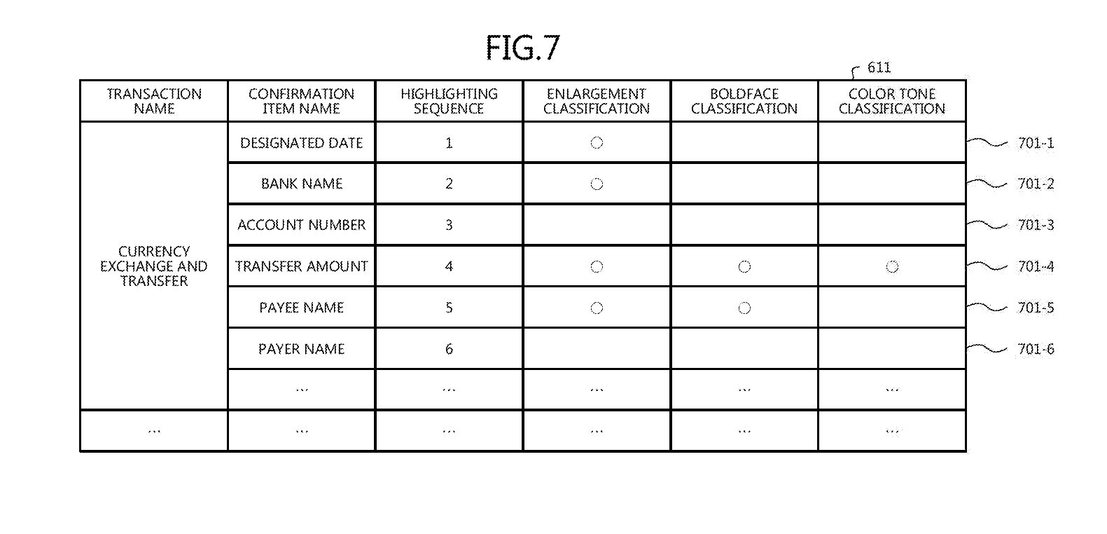

The tablet terminal 203 is configured to access a highlighting table 611. The highlighting table 611 is stored in a storage device such as the RAM 303 and the disk 305. An example of storage contents of the highlighting table 611 will be described with reference to FIG. 7.

The operation accepting unit 601 accepts simultaneous operations to the predetermined multiple regions of the touch panel 102 of the tablet terminal 203.

In the explanation mode, the operation accepting unit 601 may accept an operation to the predetermined multiple regions and may not accept an operation to regions different from the predetermined multiple regions among the regions of the touch panel 102.

The switching unit 602 carries out switching control between the explanation mode and the normal mode corresponding to the simultaneous operations accepted by the operation accepting unit 601.

The touch panel 102 is assumed to be displaying multiple items. In this state, in the normal mode, the operation accepting unit 601 accepts an operation of selecting one or more confirmation items among the multiple items. In the explanation mode, the display unit 603 highlights the confirmation items selected in the normal mode. For example, the display unit 603 may highlight all the confirmation items selected in the normal mode.

In the normal mode, the operation accepting unit 601 may store sequence information indicating the sequence of selection of the confirmation items in a storage area of the RAM 303, etc. In this case, when highlighting an item among the one or more items, the display unit 603 highlights an item indicated by the sequence information as being subsequent to an item corresponding to a predetermined operation to any of the predetermined multiple regions. This predetermined operation may be an operation detectable in the explanation mode and is, for example, an operation of double tapping with a finger. The sequence information is information correlating the confirmation items with values indicative of the sequence.

For example, the touch panel 102 is assumed to be displaying items of a designated date, a bank name, and a branch name. In this state, it is assumed that the operator op first touches the bank name and then touches the branch name. In this case, the operation accepting unit 601 accepts the touch operation to the bank name and the touch operation to the branch name and stores the sequence information identifying the bank name as the first in the order of confirmation and the branch name as the second in the order of confirmation.

Alternately, it is assumed that the designated data is the item explained first and is supposed to be set as an item to be explained even without being touched by the operator op. In this case, the operation accepting unit 601 accepts the touch operation to the bank name and the touch operation to the branch name and stores the sequence information identifying the designated date as the first in the sequence of confirmation, the bank name as the second in the order of confirmation, and the branch name as the third in the sequence of confirmation.

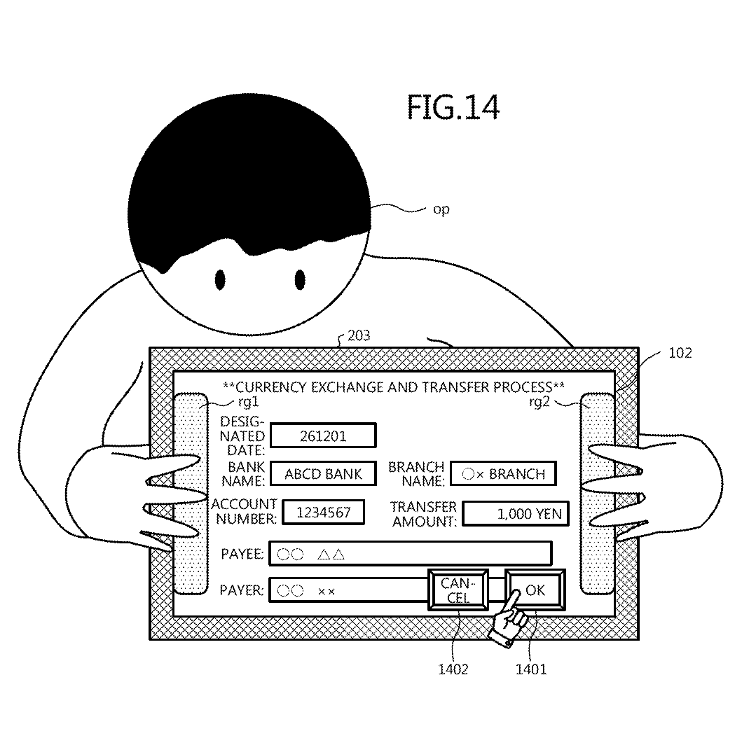

When all the confirmation items are highlighted in the explanation mode, the display unit 603 may display a button to be touched to indicate confirmation of one or more items with the person receiving the explanation of the confirmation items, i.e., the customer cu, according to a predetermined operation. A display example of the button will be described with reference to FIG. 14.

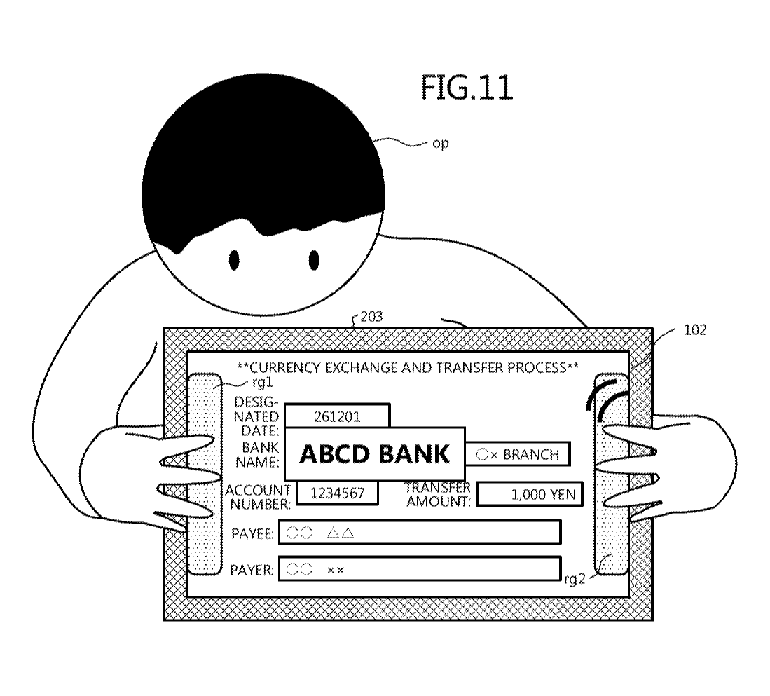

When an item is highlighted in the explanation mode, the display unit 603 may further highlight the item according to an operation to any of the predetermined multiple regions different from the predetermined operation of highlighting the subsequent item. The further highlighting includes further enlarging the display of the item and changing the color of the item. An example of the further highlighting will be described with reference to FIG. 11. The operation to any of the predetermined multiple regions different from the predetermined operation of highlighting the subsequent item may be the same operation in itself and performed in a different region. For example, if the predetermined operation of highlighting the subsequent item is an operation of touching twice with a finger on any one of the predetermined multiple regions, the operation of further highlighting may be an operation of touching twice with a finger on a region other than the one of the predetermined multiple regions.

After switching from the normal mode to the explanation mode, the display unit 603 may highlight a first item indicated by the sequence information according to a predetermined operation.

FIG. 7 is an explanatory diagram of an example of storage contents of the highlighting table 611. The highlighting table 611 is a table storing information identifying the confirmation items. The highlighting table 611 depicted in FIG. 7 has records 701-1 to 701-6.

The highlighting table 611 includes fields of a transaction name, a confirmation item name, a highlighting sequence, an enlargement classification, a boldface classification, and a color tone classification. The transaction name fields store character strings indicative of types of transaction. The confirmation item name fields store confirmation items to be highlighted. The highlighting sequence fields store values indicative of the sequence of highlighting of the confirmation items. The information stored in the highlighting sequence fields corresponding to the sequence information described with reference to FIG. 6.

The enlargement classification fields store an identifier indicating that a confirmation item is enlarged when the confirmation item is highlighted. For example, if a confirmation item is enlarged when the confirmation item is highlighted, the enlargement classification field stores “o” as the identifier. If a confirmation item is not enlarged when the confirmation item is highlighted, the value of the enlargement classification field is null. If a confirmation item is not enlarged when the confirmation item is highlighted, for example, the confirmation item may be blinked, displayed in boldface, or changed in color tone by the tablet terminal 203.

The boldface classification fields store an identifier indicating that the characters of the confirmation item are displayed in boldface when the confirmation item is further highlighted. For example, if the characters of the confirmation item are displayed in boldface when the confirmation item is further highlighted, the boldface classification field stores “o” as the identifier. If the confirmation item is not further highlighted, the value of the boldface classification field is null.

The color tone classification fields store an identifier indicting that a color change pallet for changing the color of the confirmation item is displayed when the confirmation item is further highlighted. For example, if the color change pallet is displayed when the confirmation item is highlighted, the color tone classification field stores “o” as the identifier. If the confirmation item is not further highlighted, the value of the color tone classification field is null.

For example, the record 701-1 indicates that the item name “designated date” related to the transaction name “currency exchange and transfer” is the first item to be highlighted and that when the item name “designated date” is highlighted, the item name “designated date” and the value of the item name are enlarged. The highlighting table 611 depicted in FIG. 7 indicates that the sequence of highlighting is the item names “designated date”, “bank name”, “account number”, “transfer amount”, “payee name”, “payer name”, etc., in order from the first item to be highlighted.

The format of the highlighting table 611 depicted in FIG. 7 is an example and the format is not limited to the example of FIG. 7. For example, the highlighting table 611 may omit the highlighting sequence fields and may be a table storing only the confirmation items in the sequence in which the operator op wants to obtain confirmation. Additionally, the highlighting table 611 may omit the highlighting sequence fields, may store the confirmation items in the sequence in which the operator op wants to obtain confirmation, and may have fields storing the enlargement classification, the boldface classification, and the color tone classification correlated with the confirmation items.

The highlighting table 611 may omit the enlargement classification fields. For example, the tablet terminal 203 may always enlarge the confirmation items when a predefined operation is accepted. The highlighting table 611 may omit the boldface classification fields and the color tone classification fields. For example, the tablet terminal 203 may display a confirmation item in boldface when an operation predefined for boldface is accepted while the confirmation item is highlighted. Similarly, the tablet terminal 203 may display the color change pallet when an operation predefined for changing a color tone is accepted while the confirmation item is highlighted

In the following examples, it is assumed that the highlighting table 611 does not have the respective fields of the enlargement classification, the boldface classification, and the color tone classification and that the tablet terminal 203 performs the respective displays when accepting respective operations corresponding thereto.

Hereinafter, an operation example of the customer confirmation process in the normal mode will be described with reference to FIG. 8 and an operation example of the customer confirmation process in the explanation mode will be described with reference to FIGS. 9 to 14.

FIG. 8 is an explanatory diagram of an example of registration of confirmation items to the highlighting table 611 in the normal mode. In FIG. 8, the example of registration of confirmation items to the highlighting table 611 is described as preparation for explanation to the customer cu. In the state depicted in FIG. 8, the tablet terminal 203 has accepted the transfer information 502 from the banking-center counter terminal 205.

In the normal mode, the tablet terminal 203 displays a currency exchange and transfer process screen by using the transfer information 502. In this state, the operator op touches the confirmation items in the order in which the operator op wants to highlight the items. Lines 801, 802, 803 in FIG. 8 indicate loci on the touch panel 102 touched by the operator op. It is assumed that the operator op first touches the touch panel 102 as indicated by the line 801, then touches the touch panel 102 as indicated by the line 802, and subsequently touches the touch panel 102 as indicated by the line 803. In this case, the tablet terminal 203 registers the item name “designated date” to the highlighting table 611 as the first confirmation item to be highlighted. Similarly, the tablet terminal 203 registers the item name “bank name” to the highlighting table 611 as the second confirmation item to be highlighted and registers the item name “account number” to the highlighting table 611 as the third confirmation item to be highlighted.

If the highlighting table 611 has the respective fields of the enlargement classification, the boldface classification, and the color tone classification, the tablet terminal 203 may display a screen in which the respective fields can be edited, after the confirmation items are registered to the highlighting table 611. Alternatively, the tablet terminal 203 may determine values of the enlargement classification, the boldface classification, and the color tone classification based on a character string of a confirmation item name. For example, if a “person's name” is included in a character string of a confirmation item name, a person's name may include a character having a large stroke count such as a character in an old character form and may be enlarged or displayed in boldface. Therefore, the tablet terminal 203 may store “o” in the enlargement classification and boldface classification fields of the confirmation item including the “person's name” in the item name.

FIG. 9 is an explanatory diagram (part one) of an operation example in the explanation mode. FIG. 9 depicts a scene in which the operator op starts explanation with the touch panel 102 of the tablet terminal 203 directed to the customer cu. The operator op touches the predetermined regions rg1, rg2 at both ends of the touch panel 102 with three respective fingers, i.e., the first, second, and third fingers, of both hands. The tablet terminal 203 switches from the normal mode to the explanation mode according to the simultaneous touch operations at six points to the regions rg1, rg2.

In the example of FIG. 9, the operator op touches the region rg1 with three fingers, i.e., the first, second, and third fingers, of the right hand and touches the region rg2 with three fingers, i.e., the first, second, and third fingers, of the left hand. Touching the regions rg1, rg2 with three respective fingers of the right and left hands is an example and is not a limitation. For example, the operator op may touch the regions rg1, rg2 with the first fingers of the right and left hands, and the tablet terminal 203 may switch from the normal mode to the explanation mode according to the simultaneous touch operations at two points to the predetermined regions rg1, rg2 at both ends of the touch panel 102.

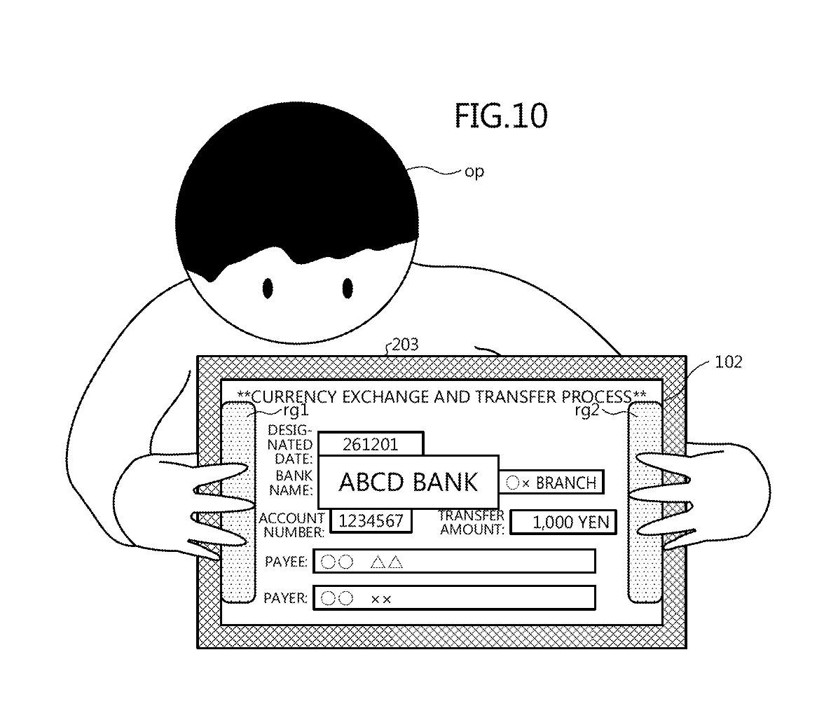

FIG. 10 is an explanatory diagram (part two) of an operation example in the explanation mode. FIG. 10 depicts a state after the tablet terminal 203 switches to the explanation mode. In this state, the operator op touches either of the regions rg1, rg2 twice with the first finger of either hand so as to highlight the confirmation items. The tablet terminal 203 detects the two touch operations to either of the regions rg1, rg2. If the two touch operations are detected, the tablet terminal 203 refers to the highlighting table 611 to highlight the subsequent confirmation item according to a sequence of the highlighting sequence.

In the example of FIG. 10, it is assumed that during highlighting of a value “261201” of the item “designated date”, the operator op touches either of the regions rg1, rg2 twice with the first finger of either hand. The tablet terminal 203 detecting the two touch operations with the first finger refers to the highlighting table 611 to highlight a value “ABCD BANK” of the item “bank name” that is subsequent to the item “designated date” in the highlighting sequence.

In this example, when detecting two touch operations after switching to the explanation mode, the tablet terminal 203 highlights the value “261201” of the item “designated date” that is the first in the highlighting sequence in the highlighting table 611. Alternatively, when switching to the explanation mode, the tablet terminal 203 may highlight the value “261201” of the item “designated date” that is the first in the highlighting sequence in the highlighting table 611.

In a method of detecting the two touch operations as operations with the first finger, for example, the tablet terminal 203 detects that the operations are performed with the first finger if the two touch operations are performed at the uppermost position of the three positions detected as being touched with the fingers.

FIG. 11 is an explanatory diagram (part three) of an operation example in the explanation mode. FIG. 11 depicts a state after the tablet terminal 203 highlights the value “ABCD BANK” of the item “bank name”. In this state, further highlighting is desired in some cases. For example, because of poor eyesight of the customer cu, the customer cu may not be able to recognize the characters of “ABCD BANK”. Alternatively, for example, the highlighted characters may include a character having a large stroke count such as a character in an old character form, and the customer cu may want to confirm details of the highlighted characters. In this case, to further highlight the “ABCD BANK”, the operator op performs an operation predefined for boldface by moving the first finger used for highlighting in FIG. 10 right and left in either of the regions rg1, rg2. The tablet terminal 203 detects the operation of moving the first finger right and left in either of the regions rg1, rg2. If the operation of moving the first finger right and left is detected, the tablet terminal 203 further highlights the value “ABCD BANK” of the item “bank name” being highlighted.

For further highlighting, for example, the tablet terminal 203 turns the characters of the item being highlighted into boldface. Alternatively, the tablet terminal 203 may increase the size of the characters of the item being highlighted. Alternatively, the tablet terminal 203 may blink the characters of the item being highlighted.

If the operation of moving the first finger right and left is no longer detected, the tablet terminal 203 cancels the further highlighting.

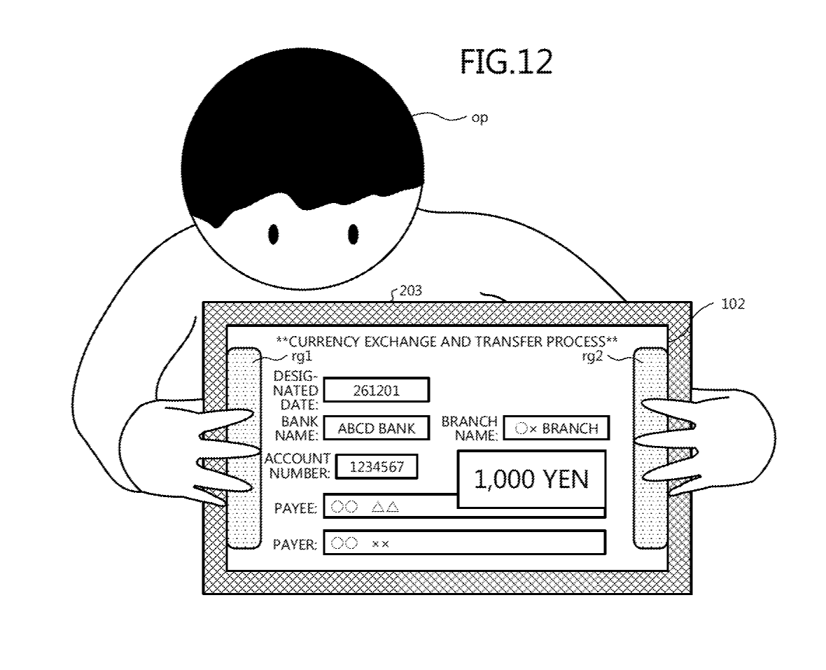

FIG. 12 is an explanatory diagram (part four) of an operation example in the explanation mode. FIG. 12 depicts a state after the tablet terminal 203 highlights a value “1234567” of the item “account number”. In this state, the confirmation of the item “account number” is assumed to be obtained from the customer cu. In this case, to highlight the subsequent item to be confirmed with the customer cu, the operator op touches either of the regions rg1, rg2 twice with the first finger of either hand. The tablet terminal 203 detects the two touch operations to either of the regions rg1, rg2. If the two touch operations are detected, the tablet terminal 203 refers to the highlighting table 611 to highlight the subsequent confirmation item according to a sequence of the highlighting sequence.

In the example of FIG. 12, it is assumed that during highlighting of the value “123456” of the item “account number”, the operator op touches either of the regions rg1, rg2 twice with the first finger of either hand. If detecting the two touch operations, the tablet terminal 203 refers to the highlighting table 611 to highlight a value “1,000 YEN” of the item “transfer amount” that is subsequent to the item “account number” in the highlighting sequence.

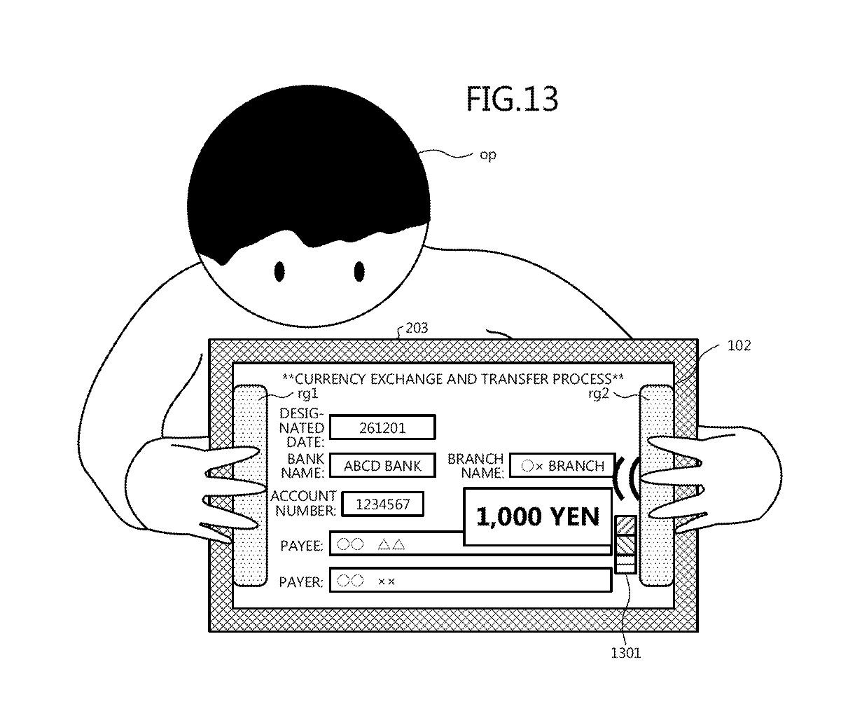

FIG. 13 is an explanatory diagram (part five) of an operation example in the explanation mode. FIG. 13 depicts a state after the tablet terminal 203 highlights the value “1,000 YEN” of the item “transfer amount”. In this state, it is assumed that since the transfer amount is particularly important, the operator op wants to further highlight the transfer amount. In this case, the operator op performs an operation predefined for changing a color tone by moving the second finger of either hand right and left in either of the regions rg1, rg2. The tablet terminal 203 detects the operation of moving the second finger right and left in either of the regions rg1, rg2. If the operation of moving the second finger right and left is detected, the tablet terminal 203 displays a color change pallet 1301. The tablet terminal 203 then changes the color of the confirmation item being highlighted to a color selected on the color change pallet 1301.

In the example of FIG. 13, the color change pallet 1301 is a pallet capable of changing the color to any of three colors. With regard to color change pallet 1301 depicted in FIG. 13, a region with hatching of diagonal lines from upper right to lower left indicates red, a region with hatching of diagonal lines from upper left to lower right indicates yellow, and a region with hatching of a horizontal line indicates blue. The operator op touches the red region in the color change pallet 1301. If the touch operation to the red region is detected in the color change pallet 1301, the tablet terminal 203 changes the character color of the value “1,000 YEN” of the item “transfer amount” to red.

FIG. 14 is an explanatory diagram (part six) of an operation example in the explanation mode. FIG. 14 depicts a state in which the customer cu has confirmed all the confirmation items described in the highlighting table 611. In this state, the operator op touches either of the regions rg1, rg2 twice with the first finger of either hand.

The tablet terminal 203 detects the two touch operations to either of the regions rg1, rg2. If the two touch operations are detected, the tablet terminal 203 refers to the highlighting table 611 to determine that the highlighting is completed for all the confirmation items. If determining that the highlighting is completed for all the confirmation items, the tablet terminal 203 displays confirmation buttons for the customer cu.

In the example of FIG. 14, the tablet terminal 203 displays an OK button 1401 and a cancel button 1402 as the confirmation buttons for the customer cu. If the regions accepting operations are limited to the regions rg1, rg2 in the explanation mode, the tablet terminal 203 additionally sets the regions displaying the OK button 1401 and the cancel button 1402 as the regions accepting operations. When completing confirmation of all the confirmation items, the customer cu touches the OK button 1401. If the touch operation to the OK button 1401 is detected, the tablet terminal 203 transmits information indicating completion of confirmation with the customer cu to the banking-center counter terminal 205. The banking-center counter terminal 205 accepts the information indicating completion of confirmation with the customer cu and executes a transfer process as a final procedure process.

After completion of the confirmation with the customer cu, the operator op moves the three respective fingers, i.e., the first, second, and third fingers, of both hands away from the regions rg1, rg2. If the touch operations of the three respective fingers, i.e., the first, second, and third fingers, of both hands are no longer detected from the regions rg1, rg2, the tablet terminal 203 switches from the explanation mode to the normal mode. When the tablet terminal 203 detects two touch operations and determines that the highlighting is completed for all the confirmation items by reference to the highlighting table 611, the tablet terminal 203 may switch from the explanation mode to the normal mode. After switching to the normal mode, the tablet terminal 203 may display the OK button 1401 and the cancel button 1402.

If the customer cu cannot understand the confirmation items, the customer cu touches the cancel button 1402. If the touch operation to the cancel button 1402 is detected, the tablet terminal 203 performs the highlighting again from the top confirmation item of the highlighting table 611 in sequence. Alternatively, the tablet terminal 203 may switch from the explanation mode to the normal mode so that the values of the confirmation items can be modified.

The process executed by the banking center system 200 will be described with reference to FIGS. 15 to 18.

FIG. 15 is a flowchart of an example of a transfer procedure process procedure. The transfer procedure process is a process of performing a procedure of the transfer process based on a transfer form filled in by the customer cu. The banking-center counter terminal 205 takes in the transfer form filled out by the customer cu with the scanner 410 as image data (step S1501). The banking-center counter terminal 205 then executes an OCR process to acquire character strings written on the transfer form taken in as an image (step S1502).

Instead of the processes of steps S1501 and S1502, the banking-center counter terminal 205 may acquire character strings input by the operator op viewing the transfer form filled in by the customer cu.

The banking-center counter terminal 205 generates the transfer information 502 correlating the acquired character strings with items in the currency exchange and transfer process screen (step S1503). For example, the transfer information 502 is data of the acquired character strings arranged in the sequence of the items in the currency exchange and transfer process screen. In this case, the transfer information 502 is “261201, ABCD bank,” including “,” as a delimiter between the acquired character strings. Alternatively, the transfer information 502 may be a set of character strings acquired by combining the items in the currency exchange and transfer process screen with the acquired character strings. In this case, the transfer information 502 is “designated data:261201, bank name:ABCD bank, . . . ” including “:” as a delimiter between the item and the acquired character string and “,” as a delimiter between the combined character strings. The transfer information 502 may be data in the extensible markup language (XML) format using the items in the currency exchange and transfer process screen as tags and the acquired character strings as data.

The banking-center counter terminal 205 transmits the transfer information 502 to the tablet terminal 203 (step S1504). After completion of the process at step S1504, the banking-center counter terminal 205 terminates the transfer procedure process. By executing the transfer procedure process, the banking-center counter terminal 205 can generate the transfer information 502.

FIG. 16 is a flowchart (part one) of an example of a customer confirmation process procedure. FIG. 17 is a flowchart (part two) of an example of the customer confirmation process procedure. The customer confirmation process is a process of obtaining confirmation from the customer cu.

The tablet terminal 203 accepts the transfer information 502 from the banking-center counter terminal 205 (step S1601). The tablet terminal 203 accepts an operation of selecting one or more confirmation items among multiple items in the display screen (step S1602). The tablet terminal 203 registers the selected confirmation items to the highlighting table 611 (step S1603). The tablet terminal 203 determines whether touch operations are detected at three positions in each of the predetermined regions rg1, rg2 at both ends of the tablet terminal (step S1604). If the touch operations are not detected at three positions at each of both ends of the tablet terminal 203 (step S1604: NO), the tablet terminal 203 executes the process at step S1604 after a certain time.

On the other hand, if the touch operations are detected at three positions in each of the predetermined regions rg1, rg2 at both ends of the tablet terminal 203 (step S1604: YES), the tablet terminal 203 switches from the normal mode to the explanation mode (step S1605).

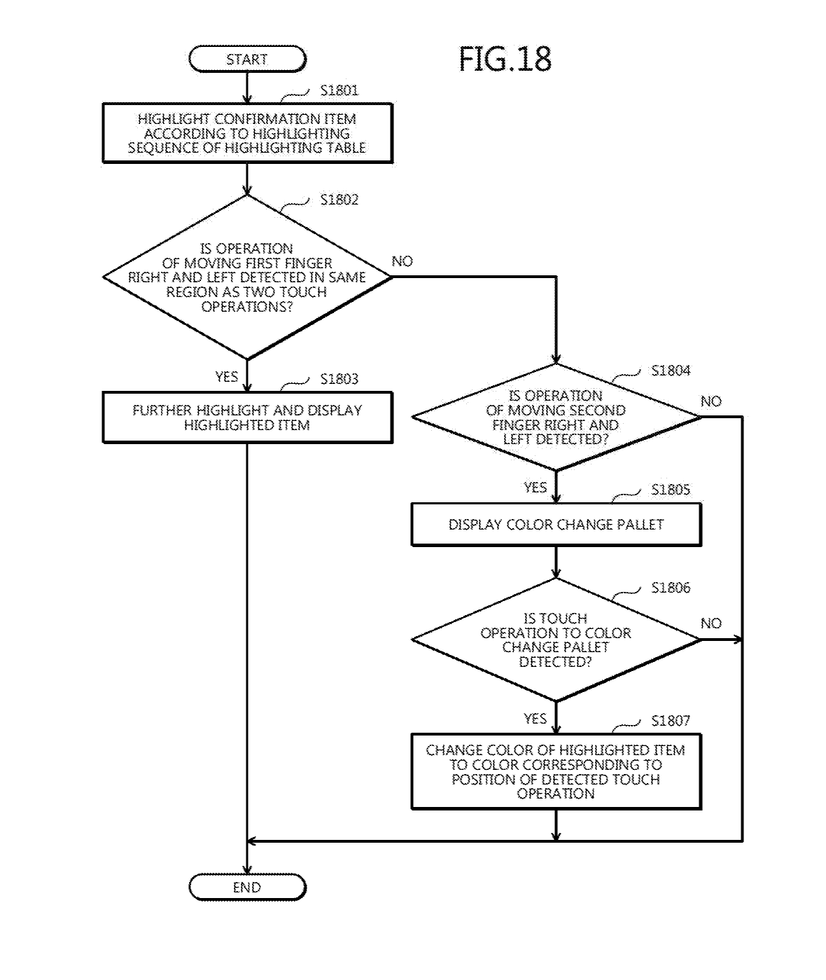

Subsequently, in FIG. 17, the tablet terminal 203 determines whether two touch operations to either of the regions rg1, rg2 at both ends are detected (step S1701). If two touch operations to either of the regions rg1, rg2 are detected (step S1701: YES), the tablet terminal 203 determines whether all the confirmation items are highlighted (step S1702). If not all the confirmation items are highlighted (step S1702: NO), the tablet terminal 203 executes a highlighting process (step S1703). The highlighting process will be described with reference to FIG. 18. If two touch operations to either of the regions rg1, rg2 are not detected (step S1701: NO), or after completion of the process at step S1703, the tablet terminal 203 goes to the process at step S1701.

If all the confirmation items are highlighted (step S1702: YES), the tablet terminal 203 displays the OK button 1401 and the cancel button 1402 as the confirmation buttons (step S1704). The tablet terminal 203 determines whether a touch operation to the OK button 1401 is detected (step S1705). If a touch operation to the OK button 1401 is not detected (step S1705: NO), the tablet terminal 203 executes the process at step S1705 again. For example, if a touch operation to the cancel button 1402 is detected, the tablet terminal 203 switches from the explanation mode to the normal mode so that the values of the confirmation items can be modified. After completion of the modification of the values of the confirmation items, the tablet terminal 203 returns to the explanation mode to execute the process at step S1705. Alternatively, if a touch operation to the cancel button 1402 is detected, the tablet terminal 203 may consider that not all the confirmation items are highlighted and may execute the process at step S1701 again.

If a touch operation to the OK button 1401 is detected (step S1705: YES), the tablet terminal 203 transmits the information indicating the completion of confirmation with the customer cu to the banking-center counter terminal 205 (step S1706). The tablet terminal 203 determines whether the touch operations to the predetermined regions rg1, rg2 at both ends are no longer detected (step S1707). If the touch operations to the predetermined regions rg1, rg2 at both ends are detected (step S1707: NO), the tablet terminal 203 executes the process at step S1707 after a certain time. On the other hand, if the touch operations to the predetermined regions rg1, rg2 at both ends are no longer detected (step S1707: YES), the tablet terminal 203 switches from the explanation mode to the normal mode (step S1708). After completion of the process at step S1708, the tablet terminal 203 terminates the customer confirmation process. By executing the customer confirmation process, the explanation mode and the normal mode can be switched with a simple operation.

FIG. 18 is a flowchart of an example of a highlighting process procedure. The highlighting process is a process of highlighting the confirmation items. The tablet terminal 203 highlights a confirmation item according to the highlighting sequence of the highlighting table 611 (step S1801). For example, if none of the confirmation items is highlighted yet, the tablet terminal 203 highlights the first confirmation item in the highlighting sequence of the highlighting table 611. If any item is being highlighted among the confirmation items, the tablet terminal 203 refers to the highlighting table 611 to highlight a subsequent item.

Subsequently, the tablet terminal 203 determines whether an operation of moving the first finger right and left is detected in the same region as the two touch operations (step S1802). If an operation of moving the first finger right and left is detected in the same region as the two touch operations (step S1802: YES), the tablet terminal 203 further highlights the highlighted item (step S1803). The tablet terminal 203 then terminates the highlighting process.

On the other hand, if an operation of moving the first finger right and left is not detected in the same region as the two touch operations (step S1802: NO), the tablet terminal 203 determines whether an operation of moving the second finger right and left is detected (step S1804). If an operation of moving the second finger right and left is detected (step S1804: YES), the tablet terminal 203 displays the color change pallet 1301 (step S1805). The tablet terminal 203 determines whether a touch operation to the color change pallet is detected (step S1806). If a touch operation to the color change pallet is detected (step S1806: YES), the tablet terminal 203 changes the color of the highlighted item to the color corresponding to the position of the detected touch operation (step S1807).

After completion of the process at step S1803 or S1807, or if an operation of moving the second finger right and left is not detected (step S1804: NO), or if a touch operation to the color change pallet is not detected (step S1806: NO), the tablet terminal 203 terminates the highlighting process. By executing the highlighting process, the tablet terminal 203 can highlight the confirmation items.

Although the process at step S1803 or the process of S1807 is executed only once for each confirmation item in the flowcharts of FIGS. 17 and 18, this is not a limitation. For example, after the process at step S1803 or the process of S1807 is executed, when the process at step S1703 is completed and step S1701 results in NO, the tablet terminal 203 may execute the process at step S1802 or the process at step S1804. As a result, the tablet terminal 203 can execute further highlighting or the item color change multiple times for one confirmation item.

As described above, the tablet terminal 203 switches between the explanation mode and the normal mode corresponding to operations of simultaneously touching the regions rg1, rg2. As a result, when screen contents are explained while the screen is shown to the customer cu, the tablet terminal 203 can switch from the normal mode to the explanation mode according to an operation easily performed when the screen is shown to the customer cu, and can facilitate the work associated with the explanation. The tablet terminal 203 can be switched between the explanation mode and the normal mode only by the simultaneous operations to the regions rg1, rg2 of the touch panel 102, and it is not necessary to display a menu, a dialogue, etc. for mode switching. Therefore, the tablet terminal 203 can suppress the load of the tablet terminal 203 required for the mode switching as compared to displaying a menu, a dialogue, etc. for mode switching.

The explanation mode of the tablet terminal 203 may be a mode with limited regions accepting operations or with limited operations. As a result, the tablet terminal 203 can prevent the contents displayed on the touch panel 102 from being changed according to an operation of the customer cu during explanation by the operator op.

In the explanation mode, the tablet terminal 203 may accept operations to the regions rg1, rg2 without accepting an operation to a region different from the regions rg1, rg2 among the regions of the touch panel 102. As a result, the tablet terminal 203 can highlight the confirmation items according to operations of the operator op to the regions rg1, rg2 while preventing the contents displayed on the touch panel 102 from being changed according to an operation of the customer cu during explanation by the operator op.

The tablet terminal 203 may accept an operation of selecting the confirmation items in the normal mode and may highlight the confirmation items in the explanation mode. As a result, the tablet terminal 203 enables the operator op to control the display of the confirmation items during explanation without blocking the line of sight of the customer cu.

The tablet terminal 203 stores the sequence information indicating the order of selection of the confirmation items in the normal mode. When highlighting an item of the confirmation items in the explanation mode, the tablet terminal 203 may highlight an item indicated by the sequence information as being subsequent to the item according to a predetermined operation to either of the regions rg1, rg2. As a result, the tablet terminal 203 enables the operator op to highlight the subsequent item during explanation without blocking the line of sight of the customer cu.

When an item of the confirmation items is highlighted in the explanation mode, the tablet terminal 203 may display a button to be touched to indicate that the confirmation item is confirmed by the customer cu, according to a predetermined operation to either of the regions rg1, rg2. As a result, the operator op can perform the operation of displaying the confirmation buttons for the customer cu with the same operation as that of highlighting the subsequent confirmation item and does not have to learn a new operation for displaying the confirmation buttons.

When an item of the confirmation items is highlighted in the explanation mode, the tablet terminal 203 may further highlight the item according to an operation to the regions rg1, rg2 different from the operation of highlighting the subsequent confirmation item. As a result, if it is desired to enlarge characters such as when the customer cu has poor eyesight or when an item includes a character having a large stroke count, the item can further be highlighted to make the confirmation of the item easier for the customer cu.

After switching from the normal mode to the explanation mode, the tablet terminal 203 may highlight the first item indicated by the sequence information according to the operation of highlighting the subsequent confirmation item. As a result, the operator op can start explanation from the first item of the confirmation items.

Since the tablet terminal 203 can switch to the explanation mode when the operator op supports both ends of the tablet terminal 203, and can perform the highlighting according to an operation with both supporting hands, the tablet terminal 203 can suppress the blocking of the line of sight of the customer cu.

However, conventional techniques are troublesome when work is performed in association with an explanation of the contents displayed on a touch panel type display while the touch panel type display is presented. For example, when giving an explanation, a user giving the explanation must perform an operation with care such that the line of sight of a person receiving the explanation of information displayed on the touch panel type display is not blocked by the user's fingers during the operation of the touch panel type display so as not to interfere with understanding by the person receiving explanation. This makes the operation of the touch panel type display cumbersome for the user.

One aspect of the present invention produces an effect of facilitating work associated with explanation of the contents displayed on a touch panel type display while the touch panel type display is presented.

The touch panel type operation method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A touch panel type operation terminal, wherein
the touch panel type operation terminal is configured to operate in a first operation mode and a second operation mode, the touch panel type operation terminal comprising:
a touch panel type display; and
a control circuit configured to carrying out switching control between the first operation mode and the second operation mode according to simultaneous operations to a plurality of predetermined regions of the touch panel type display.

2. The touch panel type operation terminal according to claim 1, wherein
the first operation mode is limited in terms of regions accepting operations or limited in terms of operations as compared to the second operation mode.

3. The touch panel type operation terminal according to claim 2, wherein
the plurality of predetermined regions is regions at both ends of the touch panel type display, and
the control circuit, in the first operation mode, accepts an operation to the plurality of predetermined regions and does not accept an operation to a region different from the plurality of predetermined regions among regions of the touch panel type display.

4. The touch panel type operation terminal according to claim 1, wherein
the touch panel type display displays a plurality of items,
the control circuit, in the second operation mode, accepts an operation of selecting one or more items of the plurality of items, and
the control circuit, in the first operation mode, highlights the selected one or more items.

5. The touch panel type operation terminal according to claim 4, wherein
the control circuit, in the second operation mode, stores to a storage area, sequence information indicating a sequence of selection of the one or more items, and
the control circuit, when highlighting a first item of the one or more items in the first operation mode, highlights a second item indicated by the sequence information as being subsequent to the first item according to a predetermined operation to a region of the plurality of predetermined regions.

6. The touch panel type operation terminal according to claim 5, wherein
the control circuit, when highlighting the one or more items in the first operation mode, displays according to the predetermined operation, a button to be touched to indicate that the one or more items are confirmed by a person receiving explanation of the one or more items.

7. The touch panel type operation terminal according to claim 5, wherein
the control circuit, when highlighting the first item in the first operation mode, further highlights the first item according to an operation to a region of the plurality of predetermined regions different from the predetermined operation.

8. The touch panel type operation terminal according to claim 5, wherein
the control circuit, after switching from the second operation mode to the first operation mode, highlights a starting item indicated by the sequence information according to the predetermined operation.

9. A touch panel type operation method of a computer, wherein
the computer has a touch panel type display and is configured to operate in a first operation mode and a second operation mode,
the method comprising:
accepting, by the computer, simultaneous operations to a plurality of predetermined regions of the touch panel type display; and
switching between the first operation mode and the second operation mode, by the computer, according to the simultaneous operations.

10. The touch panel type operation method according to claim 9, wherein
the first operation mode is limited in terms of regions accepting operations or limited in terms of operations as compared to the second operation mode.

11. The touch panel type operation method according to claim 10, wherein
the plurality of predetermined regions is regions at both ends of the touch panel type display, and
the accepting includes accepting in the first operation mode, an operation to the plurality of predetermined regions and not accepting an operation to a region different from the plurality of predetermined regions among regions of the touch panel type display.

12. The touch panel type operation method according to claim 9, wherein
the touch panel type display displays a plurality of items, and
the accepting includes accepting in the second operation mode, an operation of selecting one or more items of the plurality of items,
the touch panel type operation method further comprising
highlighting, by the computer in the first operation mode, the selected one or more items.

13. A non-transitory, computer-readable recording medium storing therein a touch panel type operation program that causes a computer to execute a process comprising:
accepting simultaneous operations to a plurality of predetermined regions of a touch panel type display; and
switching between a first operation mode and a second operation mode according to the simultaneous operations, wherein
the computer has the touch panel type display and is configured to operate in the first operation mode and the second operation mode.

14. The recording medium according to claim 13, wherein
the first operation mode is limited in terms of regions accepting operations or limited in terms of operations as compared to the second operation mode.

15. The recording medium according to claim 14, wherein
the plurality of predetermined regions is regions at both ends of the touch panel type display, and
the accepting includes accepting in the first operation mode, an operation to the plurality of predetermined regions and does not accept an operation to a region different from the plurality of predetermined regions among regions of the touch panel type display.

16. The recording medium according to claim 13, wherein
the touch panel type display displays a plurality of items, and
the accepting includes accepting in the second operation mode, an operation of selecting one or more items of the plurality of items,
the process further comprising highlighting in the first operation mode, the selected one or more items.
